(19) United States
(12) Patent Application Publication
(10) Pub. No.: US 2026/0331512 A1
(43) Pub. Date: Oct. 22, 2026

(54) ELECTRODE FOR BATTERY, MANUFACTURING METHOD THEREOF AND BATTERY COMPRISING THE SAME

(71) Applicant: UIF (University Industry Foundation), Yonsei University, Seoul (KR)

(72) Inventors: Sang-Young LEE, Seoul (KR); Hyunseok MOON, Seoul (KR); Myeong-Hwa RYOU, Seoul (KR); Seoyeon MIN, Seoul (KR)

(73) Assignee: UIF (University Industry Foundation), Yonsei University, Seoul (KR)

(21) Appl. No.: 19/545,274

(22) Filed: Feb. 20, 2026

(30) Foreign Application Priority Data
Feb. 21, 2025 (KR) 10-2025-0022827

(51) Int. Cl. H01M 4/62; H01M 4/02; H01M 4/04; H01M 10/052

(52) U.S. Cl. CPC H01M 4/623; H01M 4/0404; H01M 4/0435; H01M 4/0471; H01M 10/052; H01M 2004/021

(57) ABSTRACT

The present invention relates to a secondary battery, particularly an electrode for a lithium-sulfur battery, a manufacturing method thereof, and a secondary battery comprising the same, particularly a lithium-sulfur battery, and more specifically, the electrode for a secondary battery, particularly for a lithium-sulfur battery, of the present invention includes a cationic nanocellulose binder surface-modified with a cationic functional group, thereby increasing the specific surface area where the cationic nanocellulose binder contacts the conductive material and the active material, which can simultaneously improve the adhesion within the electrode and the adhesion between the electrode and the current collector, and by inducing 3-dimensional growth of lithium sulfide, it can suppress the shuttle effect of lithium polysulfides and passivation of the electrode, and increase the loading amount of the active material and the specific capacity of the battery.

### CROSS-REFERENCE TO RELATED APPLICATIONS

This application claims priority to Korean Patent Application No. 10-2025-0022827, filed on Feb. 21, 2025, and all the benefits accruing therefrom under 35 U.S.C. § 119, the contents of which in its entirety are herein incorporated by reference.

### BACKGROUND

### 1. Field

The present invention relates to a secondary battery, particularly an electrode for a lithium-sulfur battery, a manufacturing method thereof, and a secondary battery comprising the same, particularly a lithium-sulfur battery.

### 2. Description of Related Art

As existing lithium-ion batteries reach the limit of energy density, new battery systems capable of replacing them are attracting attention. Although lithium-sulfur batteries are emerging as candidates to replace lithium-ion batteries because they can achieve high energy density through high specific capacity expression, in the wet process using existing process solvents, cracks occurred due to non-uniform dispersion of the conductive material and active material within the electrode, making it difficult to manufacture high-loading and high-capacity electrodes.

Since this is lower than the capacity per area of commercialized lithium-ion batteries, interest in dry processes that do not use process solvents is emerging to overcome this. In order to manufacture high-loading electrodes through a dry process, fibrous PTFE (polytetrafluoroethylene) binders have recently been attracting attention, but PTFE binders have non-polar characteristics, so their adhesion to the current collector is low, and their interaction with lithium polysulfides is insignificant, causing diffusion phenomena of lithium polysulfides to the anode (hereinafter shuttle effect) and electrode passivation issues. In addition, since the PTFE binder is a fluorine-based material and a substance that may be affected by per- and polyfluoroalkyl substances (PFAS) regulations, its use in future battery processes may be restricted.

Therefore, it is necessary to research and develop a new binder for dry processes that is not subject to environmental regulations while maximizing the interaction with lithium polysulfides and having higher adhesion compared to existing PTFE.

### REFERENCE

Korean Patent Publication No. 2017-0035817

### SUMMARY

To solve the problems as described above, an objective of the present invention is to provide a secondary battery including a cationic nanocellulose binder surface-modified with a cationic functional group, particularly an electrode for a lithium-sulfur battery.

In addition, an objective of the present invention is to provide a secondary battery including the electrode according to the present invention, particularly a lithium-sulfur battery.

In addition, an objective of the present invention is to provide a device including the secondary battery according to the present invention, particularly a lithium-sulfur battery.

In addition, an objective of the present invention is to provide a method for manufacturing an electrode for a secondary battery, particularly a lithium-sulfur battery.

The present invention provides an electrode for a secondary battery, particularly for a lithium-sulfur battery, comprising a binder including cationic nanocellulose, or cationic nanocellulose and a fluorine-based polymer; a conductive material; and an active material; wherein the cationic nanocellulose is surface-modified with a cationic functional group by heat-treating a mixture including a cellulose nanofiber dispersion and a cationic monomer.

In addition, the present invention provides a secondary battery including the electrode according to the present invention, particularly a lithium-sulfur battery.

In addition, the present invention provides a device including the secondary battery according to the present invention, particularly a lithium-sulfur battery, wherein the device is any one selected from a communication device, a transportation device, and an energy storage device.

In addition, the present invention provides a method for manufacturing an electrode for a secondary battery, particularly a lithium-sulfur battery, comprising the steps of preparing cationic nanocellulose surface-modified with a cationic functional group; preparing an electrode mixed powder including the cationic nanocellulose, or a binder including cationic nanocellulose and a fluorine-based polymer, a conductive material, and an active material; and coating the electrode mixed powder on a substrate and then rolling it to manufacture an electrode for a secondary battery, particularly a lithium-sulfur battery.

The electrode for a secondary battery, particularly for a lithium-sulfur battery, of the present invention includes a cationic nanocellulose binder surface-modified with a cationic functional group, thereby increasing the specific surface area where the cationic nanocellulose binder contacts the conductive material and the active material, which can simultaneously improve the adhesion within the electrode and the adhesion between the electrode and the current collector, and by inducing 3-dimensional growth of lithium sulfide, it can suppress the shuttle effect of lithium polysulfides and passivation of the electrode, and increase the loading amount of the active material and the specific capacity of the battery.

In addition, the electrode for a secondary battery, particularly for a lithium-sulfur battery, of the present invention promotes the interaction between the binder and lithium polysulfides, remarkably increasing the lifespan characteristics and reversibility of the battery, and has an eco-friendly advantage as it is not subject to environmental regulations.

The effects of the present invention are not limited to the effects mentioned above. It should be understood that the effects of the present invention include all effects inferable from the following description.

### BRIEF DESCRIPTION OF THE DRAWINGS

FIG. 1 is a schematic diagram of an electrode for a lithium-sulfur battery including a cationic cellulose binder according to the present invention.

FIG. 2 is a photograph of the sulfur electrode manufactured in Example 2 according to the present invention.

FIG. 3 is an SEM photograph showing the electrodeposition aspect of lithium sulfide after discharging for a lithium-sulfur battery including a PTFE binder-based electrode of Comparative Example 2 according to the present invention.

FIG. 4 is an SEM photograph showing the electrodeposition aspect of lithium sulfide after discharging for a lithium-sulfur battery including a cationic nanocellulose binder-based sulfur electrode of Example 3 according to the present invention.

FIG. 5 is a graph of specific capacity after charging and discharging of the lithium-sulfur batteries manufactured in Example 3 and Comparative Example 2 according to the present invention.

FIG. 6 is a graph of lifespan characteristics after 30 cycles of charging and discharging of the lithium-sulfur battery manufactured in Example 3 according to the present invention.

### DETAILED DESCRIPTION

The present invention relates to a secondary battery, particularly an electrode for a lithium-sulfur battery, a manufacturing method thereof, and a secondary battery comprising the same, particularly a lithium-sulfur battery.

As described above, fibrous PTFE (polytetrafluoroethylene) binders have recently been attracting attention to manufacture high-loading electrodes through a dry process, but PTFE binders have non-polar characteristics, so their adhesion to the current collector is low, and their interaction with lithium polysulfides is insignificant, causing diffusion phenomena of lithium polysulfides to the anode (hereinafter shuttle effect) and electrode passivation issues. In addition, since the PTFE binder is a fluorine-based material and a substance that may be affected by per- and polyfluoroalkyl substances (PFAS) regulations, there was a problem that its use in future battery processes is restricted.

Accordingly, in the present invention, by manufacturing an electrode for a lithium-sulfur battery including a cationic nanocellulose binder surface-modified with a cationic functional group, the cationic nanocellulose binder increases the specific surface area contacting the conductive material and the active material, thereby simultaneously improving the adhesion within the electrode and the adhesion between the electrode and the current collector, and by inducing 3-dimensional growth of lithium sulfide, it is possible to suppress the shuttle effect of lithium polysulfides and passivation of the electrode, and increase the loading amount of the active material and the specific capacity of the battery. Furthermore, it promotes the interaction between the binder and lithium polysulfides, remarkably increasing the lifespan characteristics and reversibility of the battery, and has an eco-friendly advantage as it is not subject to environmental regulations.

Specifically, the present invention provides an electrode for a lithium-sulfur battery comprising a binder including cationic nanocellulose, or cationic nanocellulose and a fluorine-based polymer; a conductive material; and an active material; wherein the cationic nanocellulose is surface-modified with a cationic functional group by heat-treating a mixture including a cellulose nanofiber dispersion and a cationic monomer.

The cationic functional group in the cationic nanocellulose may interact with lithium cations and polysulfides anions, respectively, during charging and discharging to induce 3-dimensional growth of lithium sulfide. A general ionic binder has a large ion bonded to a functional group, forming a weak ionic bond with a lithium ion, which is a strong cation. That is, the cationic nanocellulose may include a strong anionic group and a weak cationic group capable of strongly interacting with a strong lithium cation and a weak polysulfides anion, respectively, based on the HSAB (Hard-Soft Acid-Base) theory.

According to the HSAB (Hard-Soft Acid-Base) theory, the lithium cation (Li⁺) corresponds to a hard acid, and the polysulfides anion (Sₓ²⁻) corresponds to a soft base. Anionic groups such as nitrate ions (NO₃⁻) or chloride ions (Cl⁻) included in the cationic nanocellulose of the present invention are hard bases and strongly interact with lithium cations which are hard acids, and the cationic group introduced into the cationic nanocellulose of the present invention includes primary to quaternary ammonium ions, and particularly in the case of a quaternary ammonium ion (NR₄⁺, R is an organic substituent) form to which an organic substituent is bonded, the charge density is dispersed by the organic substituent so that soft acid characteristics can be more effectively imparted. Due to these soft acid characteristics, the cationic group can effectively interact with the polysulfides anion which is a soft base, and in this respect, the quaternary ammonium ion is most preferred.

The degree of substitution of the cationic functional group of the cationic nanocellulose may be 0.05 to 0.5, and preferably 0.1 to 0.3. Also, the zeta potential of the cationic nanocellulose may be +10 to +60 mV, and preferably +20 to +50 mV.

Previously, ionic binders were designed considering only the ionicity of lithium polysulfides, but in the present invention, by applying cationic nanocellulose composed of strong anions and weak cations as a binder, a more powerful shuttle suppression effect can be expressed by considering even the ionic strength of lithium polysulfides. This has technical significance in that, unlike conventional carbon materials which rely on physical confinement using pores and show limitations during long-term cycles, the present invention fundamentally controls the elution of polysulfides through chemical anchoring. Also, the cationic nanocellulose binder is a binder for a dry process and can have excellent adhesion between the electrode and the current collector even at high loading of the active material.

Specifically, the cationic functional group includes at least one cationic group selected from the group consisting of primary to quaternary ammonium ions, imidazolium ions (C₃H₅N₂⁺), pyridinium ions (C₅H₆N⁺), phosphonium ions (P(C₂H₅)₄⁺), sulfonium ions (S(CH₃)₃⁺), pyrrolidinium ions (C₄H₁₀N⁺), guanidinium ions (C(NH₂)₃⁺), isouronium ions, thiouronium ions, piperidinium ions (C₅H₁₂N⁺), methylium ions (CH₃⁺), and morpholinium ions (C₄H₁₀NO⁺); and at least one anionic group selected from the group consisting of chloride ions, nitrate ions, TFSI⁻ (C₂F₆NO₄S₂⁻), BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻(TFSI⁻), N(COCF₃)(SO₂CF₃)⁻, N(SO₂F)₂⁻, N(CN)₂⁻, C(CN)₃⁻, SCN⁻, SeCN⁻, CuCl₂⁻, and AlCl₄⁻.

The cationic functional group can effectively promote interaction with lithium polysulfides (Li₂Sₓ, x=1~8) generated during the charging and discharging process of the lithium-sulfur battery, inducing 3-dimensional growth of lithium sulfide (Li₂S), which is a discharge product, and consequently, this can contribute to improving the reversibility of the battery during the charging and discharging process.

Preferably, the cationic group of the cationic functional group may be a primary to quaternary ammonium ion, and the anionic group may be a TFSI⁻ (C₂F₆NO₄S₂⁻) or nitrate ion (NO₃-), and most preferably, the cationic group may be a quaternary ammonium ion, and the anionic group may be a nitrate ion or chloride ion or TFSI⁻ (C₂F₆NO₄S₂⁻).

The cellulose nanofiber dispersion may be one obtained by mixing cellulose nanofibers in a basic solution consisting of sodium hydroxide, urea, or a mixture thereof, followed by ultrasonic treatment. Preferably, the basic solution may be a mixture of sodium hydroxide and urea.

The cellulose nanofiber is an eco-friendly biomass having excellent mechanical strength, and has a high specific surface area and excellent dispersibility, which may enable uniform electrode manufacturing even at a high active material mass per area. The cellulose nanofibers may have a diameter of 1 to 500 nm and an average fiber length of 0.01 to 2,000 μm, preferably a diameter of 10 to 300 nm and an average fiber length of 0.01 to 100 μm, and most preferably a diameter of 30 to 100 nm and an average fiber length of 0.05 to 10 μm. In particular, if the diameter of the cellulose nanofiber exceeds 500 nm or the average fiber length exceeds 2,000 μm, the movement path of lithium ions may be obstructed, and ionic conductivity may decrease.

The cationic monomer may be at least one selected from the group consisting of (2,3-epoxypropyl)trimethylammonium chloride, (3-chloro-2-hydroxypropyl)trimethylammonium chloride, (3-chloro-2-hydroxypropyl)-lauryldimethylammonium chloride, (3-chloro-2-hydroxypropyl)stearyldimethylammonium chloride, and (methacrylamidopropyl)trimethylammonium chloride, 3-chloropropylimidazolium, 2-hydroxypropylimidazolium, 3-chloropropylpyridinium, 2-hydroxyethylpyridinium, 3-chloropropyltriphenylphosphonium, 3-chloropropyltributylphosphonium, 3-chloropropyldimethylsulfonium, 2-hydroxypropyldimethylsulfonium, 1,3-dichloropropylguanidinium, N-(3-chloropropyl)guanidinium, 3-chloropropylisouronium, 2-hydroxyethylmorpholinium, triethyloxonium tetrachloride phosphate, trimethyloxonium tetrachloride phosphate, N,N-dimethylhydrazine, N,N-diethylhydrazine, methylazonium, ethylazonium, 2-methyloxazolinium, 2-ethyloxazolinium, 2-methylthiazolinium, 2-ethylthiazolinium, 1-methylpiperazinonium, 1,4-dimethylpiperazinonium, and 1,2,3-triazolinium, 1,2,4-triazolinium.

Preferably, the cationic monomer may be (3-chloro-2-hydroxypropyl)trimethylammonium chloride, (2,3-epoxypropyl)trimethylammonium chloride, or a mixture thereof, and most preferably, it may be (3-chloro-2-hydroxypropyl)trimethylammonium chloride.

The weight ratio of the cellulose nanofibers and the cationic monomer in the mixture may be mixed at 1:12-18, preferably 1:13-17, most preferably 1:14-16.

At this time, in the case where the weight ratio of the cellulose nanofibers and the cationic monomer is outside the range of 1:12-18, 3-dimensional growth of lithium sulfide does not occur during charging and discharging, so the shuttle effect of lithium polysulfides and a passivation film may be formed on the electrode surface.

In particular, when the weight ratio is within the preferred weight ratio range of 1:13-17, regardless of the usage conditions, cationic functional groups are uniformly introduced onto the nanocellulose surface, so re-dissolution of the binder in the electrolyte does not occur, thereby eliminating the risk of structural collapse of the electrode, and the dispersion of cationic nanocellulose maintains a stable colloidal state so that irreversible hornification between nanofibers does not occur even after freeze-drying, preserving the individual nanofiber form and securing the fluidity of the powder for the dry process; whereas, when it deviates from the above preferred weight ratio range, depending on the usage conditions, unexpected problems may be observed where the binder swells or dissolves in the electrolyte due to the remaining excessive unreacted monomer, causing the active material to fall off, and the dispersion of cationic nanocellulose fails to maintain a stable colloidal state, causing irreversible hornification between nanofibers during the freeze-drying process, resulting in the loss of individual nanofiber forms and significantly reducing the fluidity of the powder for the dry process; thus, it is preferable to satisfy the above weight ratio range.

Also, when the weight ratio is within the more preferred weight ratio range of 1:14-16, it is more preferable because the degree of substitution of the cationic functional group is the highest, which can further improve the adhesion between the electrode and the current collector. In particular, when the weight ratio is within the more preferred weight ratio range of 1:14-16, regardless of the usage conditions, the electrolyte contact angle on the electrode surface decreases rapidly, dramatically improving electrolyte wettability, thereby remarkably shortening the time required for electrolyte impregnation; whereas, when it deviates from the above more preferred weight ratio range, depending on the usage conditions, the initial battery performance is similar, but the effect of reducing the electrolyte contact angle on the electrode surface is not observed, so the dramatic improvement in electrolyte wettability does not appear and the time required for electrolyte impregnation may not be shortened; thus, it is more preferable to satisfy the above weight ratio range.

The binder may mainly include cationic nanocellulose, and may include cationic nanocellulose and a fluorine-based polymer if necessary.

The fluorine-based polymer may be at least one selected from the group consisting of polytetrafluoroethylene (PTFE), polyvinylidene fluoride (PVDF), vinylidene fluoride-hexafluoropropylene copolymer (PVDF-co-HEP), and chlorotrifluoroethylene (CFTF), but is not limited thereto. Preferably, the fluorine-based polymer may be polytetrafluoroethylene (PTFE).

When cationic nanocellulose and a fluorine-based polymer are included as the binder, the mechanical strength and ionic conductivity of the electrode can be optimized. At this time, the cationic nanocellulose and the fluorine-based polymer may be mixed in a weight ratio of 9:1 to 1:9, preferably 8:2 to 2:8, and most preferably 3:7 to 7:3. If the weight ratio of the cationic nanocellulose and the fluorine-based polymer is less than 1:9, the mechanical strength of the electrode may be significantly reduced, and if it exceeds 9:1, the ionic conductivity of the electrode may not reach the expected level.

The binder may be included in an amount of 0.1 to 3% by weight, preferably 0.5 to 3% by weight, and most preferably 1 to 3% by weight, based on 100% by weight of the electrode for a lithium-sulfur battery.

In particular, when (1) the binder includes cationic nanocellulose, (2) the cationic functional group includes a cationic group of primary to quaternary ammonium ions and an anionic group of nitrate ions or chloride ions or TFSI⁻ (C₂F₆NO₄S₂⁻), (3) the cellulose nanofibers have a diameter of 30 to 100 nm and an average fiber length of 0.05 to 10 μm, (4) the cationic monomer is (3-chloro-2-hydroxypropyl)trimethylammonium chloride, and (5) the cellulose nanofibers and cationic monomer in the mixture are mixed at a weight ratio of 1:14 to 16, regardless of usage conditions, the shuttle effect due to polysulfides adsorption is suppressed, 3-dimensional growth of lithium sulfide is induced, uniform binder/conductive material distribution within the electrode is secured, and electrode/current collector adhesion is improved, thereby securing the morphological stability of the electrode regardless of usage conditions; whereas, if any one of the above conditions is not met, depending on the usage conditions, suppression of the shuttle effect of lithium polysulfides may be insufficient, 3-dimensional growth of lithium sulfide may not occur leading to passivation of the electrode, and the conductive material and active material within the electrode may be lost or cracks may occur after charging and discharging, which may reduce the lifespan of the electrode; thus, it is preferable to satisfy all of the above conditions.

When replacing the chloride ion of the cationic nanocellulose with a nitrate ion or TFSI⁻ (C₂F₆NO₄S₂⁻), LiNO₃ or LiTFSI salt may be mixed into the cationic nanocellulose dispersion to induce anion exchange.

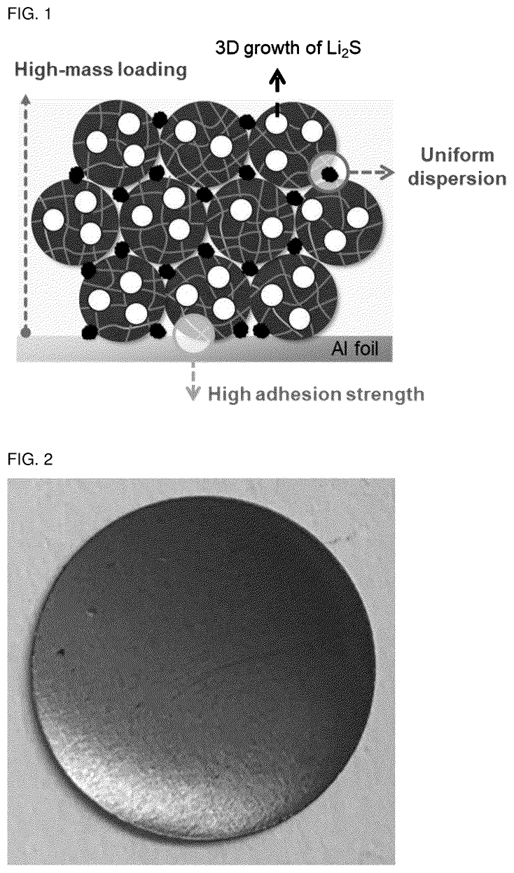

FIG. 1 is a schematic diagram of an electrode for a lithium-sulfur battery including a cationic cellulose binder according to the present invention. Referring to FIG. 1, the electrode for a lithium-sulfur battery shows that the conductive material and active material are evenly and uniformly dispersed in the cationic cellulose binder having a high specific surface area, lithium sulfide (Li₂S) grows 3-dimensionally due to the interaction between lithium polysulfides and the cationic nanocellulose binder, and the electrode is firmly adhered well on the current collector.

As described above, the electrode for a lithium-sulfur battery of the present invention can express high specific capacity even at a high loading of 5 mg_{sulfur}/cm² or more, and due to the interaction between lithium polysulfides and the cationic nanocellulose binder, lithium sulfide (Li₂S), which is the discharge product of the lithium-sulfur battery, grows 3-dimensionally to suppress the shuttle effect of lithium polysulfides and passivation of the electrode, improving the reversibility of the battery, and thereby can have high specific capacity and lifespan characteristics.

The conductive material usable in the present invention may be at least one selected from the group consisting of multi-walled carbon nanotubes (MWCNT), single-walled carbon nanotubes (SWCNT), carbon black, Ketjenblack, acetylene black, graphene, graphene oxide, reduced graphene oxide, carbon fiber, and activated carbon, but is not limited thereto.

The active material usable in the present invention may be at least one selected from the group consisting of sulfur (S₈), sulfur-carbon composite, sulfur-graphene composite, sulfur-carbon nanotube composite, organosulfur compound, and sulfur-polymer composite, but is not limited thereto.

The electrode may include 70 to 95% by weight of the active material, 2 to 20% by weight of the conductive material, and 0.1 to 11% by weight of the binder based on 100% by weight of the electrode (provided that the sum of the contents of the active material, conductive material, and binder is 100% by weight or less), and preferably may include 80 to 95% by weight of the active material, 3 to 15% by weight of the conductive material, and 0.5 to 5% by weight of the binder.

The electrode of the present invention may be most preferably applied to a lithium-sulfur battery, but is not limited thereto, and the high specific surface area and excellent adhesion of the cationic nanocellulose binder can contribute to improving the mechanical stability of the electrode and the adhesion with the current collector even in various secondary battery systems such as lithium-ion batteries, lithium metal batteries, sodium-ion batteries, and zinc-air batteries.

In addition, the present invention provides a lithium-sulfur battery including the electrode according to the present invention.

In addition, the present invention provides a device including the lithium-sulfur battery according to the present invention, wherein the device is any one selected from a communication device, a transportation device, and an energy storage device.

In addition, the present invention provides a method for manufacturing an electrode for a lithium-sulfur battery comprising the steps of preparing cationic nanocellulose surface-modified with a cationic functional group; preparing an electrode mixed powder including the cationic nanocellulose, or a binder including the cationic nanocellulose and a fluorine-based polymer, a conductive material, and an active material; and coating the electrode mixed powder on a substrate and then rolling it to manufacture an electrode for a lithium-sulfur battery.

The rolling may be performed by a roll press or flat plate press at a temperature of 30 to 120 °C, and preferably may be performed at a temperature of 40 to 80 °C.

The substrate may be at least one selected from the group consisting of aluminum foil, carbon-coated aluminum foil, copper foil, stainless steel foil, and nickel foil, but is not limited thereto.

The step of preparing cationic nanocellulose surface-modified with a cationic functional group may include the steps of adding cellulose nanofibers to a basic solution and then ultrasonically treating to prepare a cellulose nanofiber dispersion; mixing a cationic monomer with the cellulose nanofiber dispersion to prepare a mixture; and heat-treating the mixture to prepare cationic nanocellulose.

The cellulose nanofiber dispersion may be one in which cellulose nanofibers are mixed in a basic solution and then cooled, the cooled cellulose nanofibers are thawed at room temperature, and the thawed cellulose nanofibers are mixed again in the basic solution and dispersed by ultrasonic treatment.

The basic solution may be sodium hydroxide, urea, or a mixture thereof, and preferably may be a mixture of sodium hydroxide and urea.

The cellulose nanofibers may have a diameter of 1 to 500 nm and an average fiber length of 0.01 to 2,000 μm, preferably a diameter of 10 to 300 nm and an average fiber length of 0.01 to 100 μm, and most preferably a diameter of 30 to 100 nm and an average fiber length of 0.05 to 10 μm.

The ultrasonic treatment may be performed with an amplitude of 1 to 100 μm for 10 to 70 minutes, preferably with an amplitude of 10 to 80 μm for 20 to 50 minutes, and most preferably with an amplitude of 15 to 60 μm for 30 to 40 minutes. At this time, if the ultrasonic treatment amplitude is less than 1 μm or the treatment time is less than 10 minutes, the cellulose nanofibers are not sufficiently dispersed in the basic solution and may aggregate with each other, reducing the specific surface area, and conversely, if the ultrasonic treatment amplitude exceeds 100 μm or the treatment time exceeds 70 minutes, the cellulose solution may be heated and cellulose fibers may aggregate.

The cationic monomer may be at least one selected from the group consisting of (2,3-epoxypropyl)trimethylammonium chloride, (3-chloro-2-hydroxypropyl)trimethylammonium chloride, (3-chloro-2-hydroxypropyl)-lauryldimethylammonium chloride, (3-chloro-2-hydroxypropyl)stearyldimethylammonium chloride, and (methacrylamidopropyl)trimethylammonium chloride.

Preferably, the cationic monomer may be (3-chloro-2-hydroxypropyl)trimethylammonium chloride, (2,3-epoxypropyl)trimethylammonium chloride, or a mixture thereof, and most preferably, it may be (3-chloro-2-hydroxypropyl)trimethylammonium chloride.

The cellulose nanofibers and cationic monomer in the mixture may be mixed at a weight ratio of 1:12 to 18, preferably 1:13 to 17, and most preferably 1:14 to 16.

The heat treatment may be performed at a temperature of 60 to 100 °C for 7 to 14 hours, preferably at a temperature of 65 to 80 °C for 8 to 12 hours, and most preferably at a temperature of 68 to 72 °C for 9 to 11 hours.

In particular, when both the preferred heat treatment temperature and time are satisfied, regardless of usage conditions, the crystal structure of the cellulose nanofibers is maintained while cationic functional groups are selectively introduced into the amorphous region, preserving the mechanical toughness of the fibers, so that the occurrence of microcracks in the electrode during the rolling process can be suppressed, and when the dried cationic nanocellulose is redispersed in water, the irreversible hardening (hornification) phenomenon due to hydrogen bonding between fibers is suppressed, enabling 100% redispersion; whereas, if any one of the above preferred heat treatment temperature and time is not satisfied, depending on the usage conditions, unexpected problems may be observed where the crystal structure of the cellulose nanofibers is partially destroyed, leading to non-selective introduction of cationic functional groups and reduced mechanical toughness of the fibers, causing microcracks in the electrode during the rolling process, and unexpected problems may be observed where excessive dehydration reaction on the cellulose surface causes clumping during redispersion, making it impossible to prepare a uniform binder solution; thus, it is preferable to satisfy the above preferred heat treatment temperature and time.

The cationic functional group in the cationic nanocellulose may interact with lithium cations and polysulfides anions, respectively, during charging and discharging to induce 3-dimensional growth of lithium sulfide.

The cationic functional group includes at least one cationic group selected from the group consisting of primary to quaternary ammonium ions, imidazolium ions (C₃H₅N₂⁺), pyridinium ions (C₅H₆N⁺), phosphonium ions (P(C₂H₅)₄⁺), sulfonium ions (S(CH₃)₃⁺), pyrrolidinium ions (C₄H₁₀N⁺), guanidinium ions (C(NH₂)₃⁺), isouronium ions, thiouronium ions, piperidinium ions (C₅H₁₂N⁺), methylium ions (CH₃⁺), and morpholinium ions (C₄H₁₀NO⁺); and at least one anionic group selected from the group consisting of chloride ions, nitrate ions, TFSI⁻ (C₂F₆NO₄S₂⁻), BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻(TFSI⁻), N(COCF₃)(SO₂CF₃)⁻, N(SO₂F)₂⁻, N(CN)₂⁻, C(CN)₃⁻, SCN⁻, SeCN⁻, CuCl₂⁻, and AlCl₄⁻.

The binder may include cationic nanocellulose, the cationic functional group may include a cationic group of primary to quaternary ammonium ions and an anionic group of nitrate ions or chloride ions or TFSI⁻ (C₂F₆NO₄S₂⁻), the cellulose nanofibers may have a diameter of 30 to 100 nm and an average fiber length of 0.05 to 10 μm, the cationic monomer may be (3-chloro-2-hydroxypropyl)trimethylammonium chloride, and the cellulose nanofibers and cationic monomer in the mixture may be mixed at a weight ratio of 1:14 to 16.

Hereinafter, the present invention will be described in more detail based on examples, but the present invention is not limited or interpreted as being reduced by the following examples.

In addition, based on the disclosure of the present invention including the following examples, it is obvious that a person skilled in the art can easily carry out the present invention for which experimental results are not specifically presented, and it goes without saying that such variations and modifications fall within the appended claims.

Also, the experimental results presented below describe only representative experimental results of the examples and comparative examples, and the respective effects of various embodiments of the present invention not explicitly presented below will be described specifically in the corresponding sections.

### EXAMPLES

### Example 1: Preparation of Cationic Nanocellulose

Materials prepared were Cellulose Nanofiber (CNF), Sodium hydroxide (NaOH) and Urea as a basic solution, and (3-chloro-2-hydroxypropyl) trimethyl ammonium chloride was prepared as a cationic monomer.

First, a basic solution containing 7 wt % NaOH and 12 wt % Urea was prepared. Then, 1 wt % CNF was mixed into the basic solution and frozen in a freezer for 12 hours. Subsequently, the frozen CNF was thawed at room temperature, and then the CNF dissolved in the basic solution was added again and sonicated for 30 minutes with an amplitude of 30 μm to prepare a CNF dispersion. A cationic monomer was mixed into the CNF dispersion at a weight ratio of 1:15 (CNF:cationic monomer) to prepare a mixture. The mixture was heated at a temperature of 70 °C for 10 hours to prepare cationic nanocellulose. Subsequently, the cationic nanocellulose was put into dialysis tubing cellulose and washed once every 2 hours for 1 week to obtain cationic nanocellulose having a diameter of 50 nm and an average fiber length of 10 μm.

### Example 2: Preparation of Cationic Nanocellulose Binder-Based Electrode

The cationic nanocellulose binder of Example 1 was used as the binder, multi-walled carbon nanotubes (MWCNT) were used as the conductive material, and sulfur@carbon (Ketjenblack) was used as the active material. The cationic nanocellulose of Example 1 and MWCNT were mixed and freeze-dried to obtain a binder-conductive material powder. Then, the active material was mixed with the binder-conductive material powder to prepare an electrode mixed powder. At this time, the electrode mixed powder included 90 wt % active material, 7 wt % conductive material, and 3 wt % binder. Then, the electrode mixed powder was uniformly coated on a carbon-coated aluminum current collector (C coated Al) and then roll-pressed at a high temperature of 60 °C to manufacture a sulfur electrode for a lithium-sulfur battery.

### Example 3: Preparation of Lithium-Sulfur Battery Including Cationic Nanocellulose Binder-Based Sulfur Electrode

An electrolyte was prepared by mixing 0.4 M LiTFSI (Li bis(trifluoromethanesulfonyl)imide) and 0.6 M LiNO₃ (Li nitrate) in a mixed solvent in which DOL (1,3 dioxolane) and DME (1,2-dimethoxyethane) were mixed at a volume ratio of 1:1.

After vacuum drying the sulfur electrode of Example 2 at 40 °C for 12 hours, a Celgard 2400 separator was laminated on the electrode, and an electrolyte corresponding to an electrolyte-sulfur (E/S) ratio (μL/mg_{sulfur}) of 7 was applied. Thereafter, a 200 μm Li foil was laminated to manufacture a lithium-sulfur battery by a conventional method.

### Comparative Example 1: Preparation of PTFE Binder-Based Electrode

A sulfur electrode was manufactured in the same manner as in Example 2, except that a PTFE binder was used.

### Comparative Example 2: Preparation of Lithium-Sulfur Battery Including PTFE Binder-Based Electrode

A lithium-sulfur battery was manufactured in the same manner as in Example 3, except that a PTFE binder was used.

### Comparative Example 3: Preparation of Lithium-Sulfur Battery Including Cationic Nanocellulose Binder-Based Electrode of 1:8 Weight Ratio

Cationic nanocellulose was prepared in the same manner as in Example 1, except that the weight ratio of cellulose nanofibers and cationic monomer in Example 1 was changed from 1:15 to 1:8, and a sulfur electrode was manufactured in the same manner as in Example 2, and then a lithium-sulfur battery was manufactured in the same manner as in Example 3.

### Comparative Example 4: Preparation of Lithium-Sulfur Battery Including Cationic Nanocellulose Binder-Based Electrode of 1:22 Weight Ratio

Cationic nanocellulose was prepared in the same manner as in Example 1, except that the weight ratio of cellulose nanofibers and cationic monomer in Example 1 was changed from 1:15 to 1:22, and a sulfur electrode was manufactured in the same manner as in Example 2, and then a lithium-sulfur battery was manufactured in the same manner as in Example 3.

### Comparative Example 5: Preparation of Lithium-Sulfur Battery Including Cationic Nanocellulose Binder-Based Electrode Under Heat Treatment Conditions of 110 °C, 5 Hours

Cationic nanocellulose was prepared in the same manner as in Example 1, except that the heat treatment condition in Example 1 was changed from heating at 70 °C for 10 hours to heating at 110 °C for 5 hours, and a sulfur electrode was manufactured in the same manner as in Example 2, and then a lithium-sulfur battery was manufactured in the same manner as in Example 3.

### Comparative Example 6: Preparation of Lithium-Sulfur Battery Including Cationic Nanocellulose Binder-Based Electrode Under Heat Treatment Conditions of 45 °C, 18 Hours

Cationic nanocellulose was prepared in the same manner as in Example 1, except that the heat treatment condition in Example 1 was changed from heating at 70 °C for 10 hours to heating at 45 °C for 18 hours, and a sulfur electrode was manufactured in the same manner as in Example 2, and then a lithium-sulfur battery was manufactured in the same manner as in Example 3.

### Comparative Example 7: Preparation of Lithium-Sulfur Battery Including Unmodified Nanocellulose Binder-Based Electrode

A lithium-sulfur battery was manufactured in the same manner as in Example 3, except that cellulose nanofibers without cationic surface modification were used as a binder.

### Experimental Example 1: Analysis of Morphology and Stability of Electrode

The morphology and stability of the electrodes were evaluated for the sulfur electrode manufactured in Example 2 and the lithium-sulfur batteries manufactured in Example 3 and Comparative Example 2, respectively, and the results are shown in FIGS. 2 to 4.

The stability of the electrode was confirmed by the electrodeposition aspect of lithium sulfide after discharging the battery. Specifically, after the electrolyte was injected, the battery underwent a stabilization process for 6 hours. After the stabilization process, it was discharged with a current of 0.05 C for activation of the battery. Thereafter, the charge/discharge performance test was evaluated in a voltage range of 1.7 to 2.7 V with a charge/discharge current of 0.05 C/0.05 C.

FIG. 2 is a photograph of the sulfur electrode manufactured in Example 2. Referring to FIG. 2, it was confirmed that the sulfur electrode of Example 2 can be manufactured without cracks at a high loading of 9 mg/cm², which is an electrode loading amount difficult to manufacture with existing wet processes.

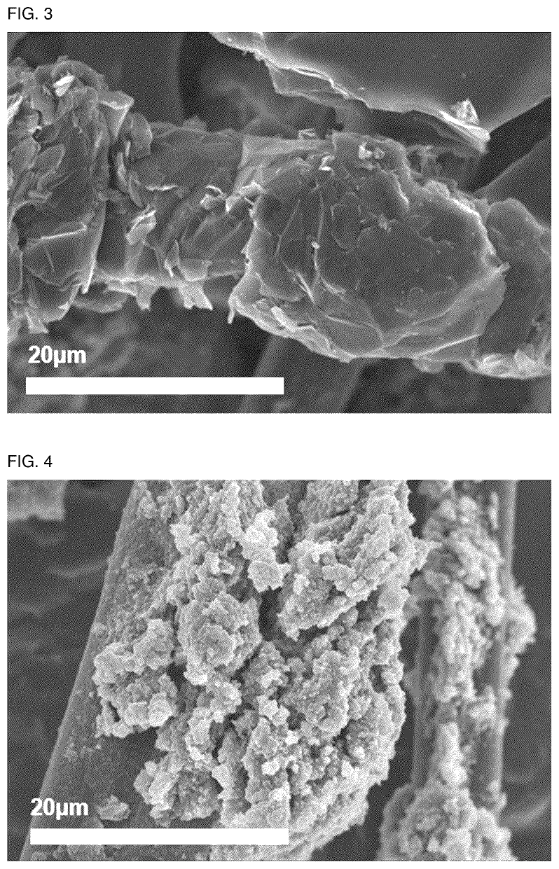

FIG. 3 is an SEM photograph showing the electrodeposition aspect of lithium sulfide after discharging for the lithium-sulfur battery of Comparative Example 2 including a PTFE binder-based electrode. Referring to FIG. 3, it was confirmed that due to the use of a PTFE binder having non-polarity, lithium sulfide grew 2-dimensionally on the conductive material, passivating the electrode.

FIG. 4 is an SEM photograph showing the electrodeposition aspect of lithium sulfide after discharging for the lithium-sulfur battery of Example 3 including a cationic nanocellulose binder-based sulfur electrode. Referring to FIG. 4, it was confirmed that due to the use of the cationic nanocellulose binder, lithium sulfide grew 3-dimensionally on the conductive material, preventing passivation of the electrode. This was because the growth aspect of lithium sulfide changed as the cationic nanocellulose binder interacted with lithium polysulfides by ionic attraction. That is, unlike in the non-polar PTFE binder of Comparative Example 2, in the cationic nanocellulose binder, the diffusion of lithium polysulfides was suppressed and the growth aspect of lithium sulfide changed according to the slowed diffusion rate.

### Experimental Example 2: Analysis of Specific Capacity and Lifespan Characteristics of Battery

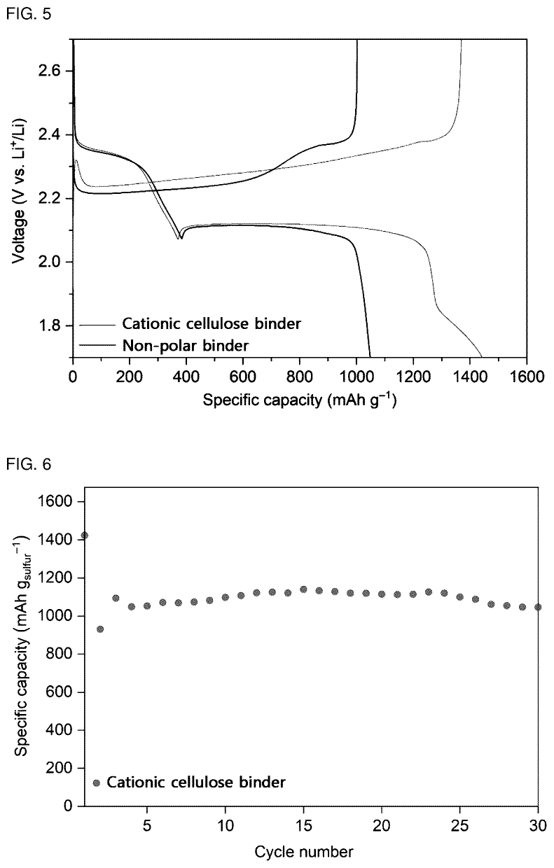

The specific capacity of the lithium-sulfur batteries manufactured in Example 3 and Comparative Example 2 was analyzed, and the results are shown in FIGS. 5 and 6. Charging and discharging were performed in the same manner as in Experimental Example 1, but for 30 cycles at 0.05 C.

FIG. 5 is a graph of specific capacity after charging and discharging of the lithium-sulfur batteries manufactured in Example 3 and Comparative Example 2. Referring to FIG. 5, in the case of Comparative Example 2, it could be seen that the use of the non-polar PTFE binder induced electrode passivation as lithium sulfide grew in a 2D form, causing low sulfur utilization in the high-loading sulfur electrode. On the other hand, in the case of the lithium-sulfur battery using the cationic nanocellulose binder of Example 3, lithium polysulfides was electrodeposited in 3D, allowing high sulfur utilization to be obtained due to the mitigation of electrode passivation. It was confirmed that the lithium-sulfur battery of Example 3 exhibited a high specific capacity of 1423 mAh/g at an electrode loading amount of 9 mg/cm². Considering that most dry lithium-sulfur electrodes exhibit a specific capacity of approximately 1200 mAh/g at an electrode loading amount of 3 mg/cm², it could be seen that the performance of the lithium-sulfur battery of Example 3 is at a very excellent level.

FIG. 6 is a graph of lifespan characteristics after 30 cycles of charging and discharging of the lithium-sulfur battery manufactured in Example 3. Referring to FIG. 6, it was confirmed that the lithium-sulfur battery of Example 3 mitigated passivation of the electrode by using the cationic nanocellulose binder, so that the specific capacity of the battery was expressed as 1000 mAh/g_{sulfur} or more, and it was maintained constantly for 30 cycles, indicating that the lifespan characteristics were remarkably improved.

### Experimental Example 3: Analysis of Battery Performance and Process Characteristics According to Weight Ratio

The specific capacity, lifespan characteristics, and process characteristics of the lithium-sulfur batteries manufactured in Example 3, Comparative Example 3, and Comparative Example 4, respectively, were analyzed. Charging and discharging were performed in the same manner as in Experimental Example 1, but for 30 cycles at 0.05 C.

### (1) Growth Aspect of Lithium Sulfide and Battery Performance

In the case of Comparative Example 3 (weight ratio 1:8), the amount of cationic monomer was insufficient, so the degree of substitution of cationic functional groups was very low, and as a result, ionic interaction with lithium polysulfides was not sufficiently expressed, so 3-dimensional growth of lithium sulfide did not occur and 2-dimensional growth was observed. Accordingly, passivation of the electrode proceeded, and the specific capacity rapidly decreased to 600 mAh/g or less after 30 cycles, and the shuttle effect of lithium polysulfides was confirmed.

In the case of Comparative Example 4 (weight ratio 1:22), despite the input of excess cationic monomer, the number of reactive hydroxyl groups on the surface of cellulose nanofibers is limited, so the degree of substitution of cationic functional groups may not increase any further. Also, a phenomenon where the binder swells in the electrolyte due to the remaining excessive unreacted monomer may be observed, and capacity reduction may occur because the active material partially fell off during the charging and discharging process.

On the other hand, in the case of Example 3 (weight ratio 1:15), as confirmed in Experimental Example 2 above, a high specific capacity of 1423 mAh/g was expressed at an electrode loading amount of 9 mg/cm², and a specific capacity of 1000 mAh/g_{sulfur} or more was maintained constantly for 30 cycles.

### (2) Colloidal Stability and Powder Fluidity

The dispersion of cationic nanocellulose prepared in Example 3 (weight ratio 1:15, within preferred range) maintained a stable colloidal state, and even after freeze-drying, irreversible aggregation (hornification) between nanofibers did not occur and individual nanofiber forms were preserved, so the fluidity of the powder for the dry process was secured well. Also, re-dissolution of the binder in the electrolyte was not observed at all, securing the structural stability of the electrode.

On the other hand, in the case of Comparative Example 3 (weight ratio 1:8, outside preferred range), the degree of substitution of cationic functional groups was insufficient, so the polarity of the nanocellulose surface was not sufficiently changed, and as a result, irreversible aggregation (hornification) between nanofibers occurred during the freeze-drying process, resulting in the loss of individual nanofiber forms. Accordingly, the fluidity of the powder for the dry process significantly decreased, making uniform electrode coating difficult.

In the case of Comparative Example 4 (weight ratio 1:22, outside preferred range), a phenomenon where the binder swells in the electrolyte due to the remaining excessive unreacted monomer was observed, and accordingly, an unexpected problem where the active material partially falls off during the charging and discharging process was confirmed.

### (3) Long-Term Storage Stability and Electrolyte Wettability

In the case of Example 3 (weight ratio 1:15, within most preferred range), even if the electrode mixed powder was left for 24 hours or more, gelation phenomenon due to agglomeration between nanocelluloses did not occur at all, ensuring long-term storage stability. In addition, the electrolyte contact angle on the electrode surface decreased rapidly, dramatically improving electrolyte wettability, and accordingly, the time required for electrolyte impregnation was remarkably shortened.

On the other hand, in the case of Comparative Example 3 (weight ratio 1:8, outside most preferred range) and Comparative Example 4 (weight ratio 1:22, outside most preferred range), the effect of reducing the electrolyte contact angle on the electrode surface was not observed, so a dramatic improvement in electrolyte wettability did not appear, and the time required for electrolyte impregnation was not shortened.

### Experimental Example 4: Analysis of Battery Performance and Process Characteristics According to Heat Treatment Conditions

The specific capacity, lifespan characteristics, and process characteristics of the lithium-sulfur batteries manufactured in Example 3, Comparative Example 5, and Comparative Example 6, respectively, were analyzed. Charging and discharging were performed in the same manner as in Experimental Example 1, but for 30 cycles at 0.05 C.

### (1) Basic Battery Performance

In the case of Comparative Example 5 (110 °C, 5 hours), thermal decomposition of cellulose nanofibers partially proceeded due to excessive heat treatment temperature, and the form of fibers was damaged, significantly reducing the specific surface area. Also, side reactions of the cationic monomer were promoted at high temperature, lowering the effective degree of substitution of cationic functional groups. As a result, the ionic interaction with lithium polysulfides was weakened, so the 3-dimensional growth of lithium sulfide was insufficient, and the specific capacity decreased to 650 mAh/g or less after 30 cycles.

In the case of Comparative Example 6 (45 °C, 18 hours), the heat treatment temperature was low, so the substitution reaction between the cationic monomer and the hydroxyl group of the cellulose nanofiber did not proceed sufficiently. Despite the long reaction time (18 hours), the degree of substitution of the cationic functional group was very low, which is judged to be because the reaction has temperature-dependent activation energy, so the substitution reaction does not proceed effectively even if the reaction time is extended below a certain temperature. As a result, interaction with lithium polysulfides was insignificant, so 3-dimensional growth of lithium sulfide did not occur, and passivation of the electrode proceeded, causing the specific capacity to rapidly decrease to 550 mAh/g or less after 30 cycles.

On the other hand, in the case of Example 3 (70 °C, 10 hours), as confirmed in Experimental Example 2 above, a high specific capacity of 1423 mAh/g was expressed at an electrode loading amount of 9 mg/cm², and a specific capacity of 1000 mAh/g_{sulfur} or more was maintained constantly for 30 cycles.

### (2) Crystal Structure Preservation and Rolling Process Characteristics

In the case of Example 3 (70 °C, 10 hours, within preferred range), as a result of XRD analysis, it was confirmed that cationic functional groups were selectively introduced into the amorphous region while the crystal structure of cellulose nanofibers was maintained. Accordingly, the mechanical toughness of the fibers was preserved, so no microcracks occurred in the electrode during the high-temperature roll pressing process at 60 °C, and the structural integrity of the electrode was maintained. Also, when the dried cationic nanocellulose was redispersed in water, the irreversible hardening (hornification) phenomenon due to hydrogen bonding between fibers was suppressed, enabling 100% redispersion.

On the other hand, in the case of Comparative Example 5 (110 °C, 5 hours, outside preferred range), as a result of XRD analysis, it was confirmed that the crystal structure of cellulose nanofibers was partially destroyed, and cationic functional groups were non-selectively introduced into the crystalline region and amorphous region, reducing the mechanical toughness of the fibers. As a result, an unexpected problem of microcracks occurring in the electrode during the rolling process was observed. Also, when the dried cationic nanocellulose was redispersed in water, clumping occurred due to excessive dehydration reaction on the cellulose surface, making it impossible to prepare a uniform binder solution.

In the case of Comparative Example 6 (45 °C, 18 hours, outside preferred range), the heat treatment temperature was low, so the substitution of cationic functional groups itself was insufficient, and it was confirmed that unreacted monomers physically remained on the cellulose surface. Even upon redispersion after drying, washing of unreacted monomers was incomplete, forming a non-uniform dispersion, and in the rolling process, an unexpected problem was observed where the electrode-current collector adhesion was significantly reduced due to slip phenomenon caused by residual monomers.

### Experimental Example 5: Comparative Analysis of Battery Performance and Electrode Characteristics According to Presence or Absence of Cationic Surface Modification

The specific capacity, lifespan characteristics, electrodeposition aspect of lithium sulfide, and electrode characteristics of the lithium-sulfur batteries manufactured in Example 3 and Comparative Example 7, respectively, were analyzed. Charging and discharging were performed in the same manner as in Experimental Example 1, but for 30 cycles at 0.05 C.

### (1) Growth Aspect of Lithium Sulfide

In the case of the lithium-sulfur battery using the unmodified nanocellulose binder of Comparative Example 7, as a result of SEM analysis after discharging, it was confirmed that lithium sulfide grew in a 2-dimensional plate-like form on the surface of the conductive material. This is judged to be because cationic functional groups did not exist on the surface of unmodified cellulose nanofibers, so ionic interaction with lithium cations and polysulfides anions was not expressed. That is, unmodified nanocellulose has only hydroxyl groups (—OH) on the surface, so interaction with lithium polysulfides was somewhat improved compared to the PTFE binder, but a dual interaction mechanism of cationic group-anionic group based on HSAB theory, like cationic nanocellulose, was absent, which was not sufficient to induce 3-dimensional growth of lithium sulfide.

On the other hand, in the case of the lithium-sulfur battery using the cationic nanocellulose binder of Example 3, as confirmed in FIG. 4 of Experimental Example 1 above, lithium sulfide grew 3-dimensionally on the surface of the conductive material, effectively suppressing passivation of the electrode.

### (2) Specific Capacity and Lifespan Characteristics of Battery

In the case of Comparative Example 7, due to partial polarity caused by hydroxyl groups of the unmodified nanocellulose binder, the initial specific capacity was somewhat improved (about 900 mAh/g) compared to Comparative Example 2 using a PTFE binder, but electrode passivation due to 2-dimensional growth of lithium sulfide gradually intensified as charging and discharging proceeded, and the specific capacity rapidly decreased to about 500 mAh/g or less after 30 cycles. This suggests that the unmodified nanocellulose did not sufficiently suppress the shuttle effect of lithium polysulfides, and irreversible passivation films were cumulatively formed on the electrode surface as charge/discharge cycles proceeded.

On the other hand, in the case of the lithium-sulfur battery using the cationic nanocellulose binder of Example 3, as confirmed in Experimental Example 2 above, a high initial specific capacity of 1423 mAh/g was expressed at an electrode loading amount of 9 mg/cm², and a specific capacity of 1000 mAh/g_{sulfur} or more was maintained constantly for 30 cycles, indicating remarkably excellent lifespan characteristics.

### (3) Electrode-Current Collector Adhesion

In the case of Comparative Example 7, adhesion was improved compared to the PTFE binder (Comparative Example 2) due to hydrogen bonding between hydroxyl groups of unmodified nanocellulose and the current collector surface, but delamination from the current collector was observed in some areas of the electrode after 30 cycles of charging and discharging. This is judged to be because the stress caused by the volume change of sulfur occurring during the charging and discharging process could not be sufficiently withstood only by the adhesion of the unmodified nanocellulose binder.

On the other hand, in the case of using the cationic nanocellulose binder of Example 3, the specific surface area of the binder increased and polarity was improved due to the introduction of cationic functional groups, thereby increasing the contact area with the conductive material and active material, and no peeling between the electrode and the current collector was observed even after 30 cycles of charging and discharging, maintaining excellent adhesion stability.

### (4) Binder Stability in Electrolyte

In the case of the unmodified nanocellulose binder of Comparative Example 7, partial swelling was exhibited when hydroxyl groups on the surface of cellulose nanofibers contacted the electrolyte (DOL/DME mixed solvent), and it was confirmed that the structural integrity of the binder gradually decreased during the long-term charging and discharging process.

On the other hand, in the case of the cationic nanocellulose binder of Example 3, the chemical stability against the electrolyte was improved as hydrophilic hydroxyl groups on the cellulose surface were substituted with cationic functional groups due to the introduction of cationic functional groups, and swelling or re-dissolution in the electrolyte was not observed at all, maintaining the structural stability of the electrode even during the long-term charging and discharging process.

Summarizing the above results, simply applying nanocellulose as a binder cannot sufficiently improve the performance of a lithium-sulfur battery, and it could be seen that only when cationic nanocellulose surface-modified with a cationic functional group is applied as a binder, dual interaction with lithium cations and polysulfides anions based on the HSAB theory is expressed, achieving induction of 3-dimensional growth of lithium sulfide, suppression of shuttle effect, suppression of electrode passivation, and remarkable improvement of electrode-current collector adhesion.

What is claimed is:

1. An electrode for a secondary battery comprising a binder, a conductive material, and an active material,
wherein the binder is cationic nanocellulose, or comprises cationic nanocellulose and a fluorine-based polymer, and
the cationic nanocellulose is surface-modified with a cationic functional group by heat-treating a mixture including a cellulose nanofiber dispersion and a cationic monomer.

2. The electrode for a secondary battery according to claim 1, wherein the secondary battery is a lithium-sulfur battery.

3. The electrode for a secondary battery according to claim 1,
wherein the cationic functional group in the cationic nanocellulose interacts with lithium cations and polysulfides anions, respectively, during charging and discharging to induce 3-dimensional growth of lithium sulfide, and
wherein the cationic functional group includes at least one cationic group selected from the group consisting of primary to quaternary ammonium ions, imidazolium ions (C₃H₅N₂⁺), pyridinium ions (C₅H₆N⁺), phosphonium ions (P(C₂H₅)₄⁺), sulfonium ions (S(CH₃)₃⁺), pyrrolidinium ions (C₄H₁₀N⁺), guanidinium ions (C(NH₂)₃⁺), isouronium ions, thiouronium ions, piperidinium ions (C₅H₁₂N⁺), methylium ions (CH₃⁺), and morpholinium ions (C₄H₁₀NO⁺); and at least one anionic group selected from the group consisting of chloride ions, nitrate ions, TFSI⁻ (C₂F₆NO₄S₂⁻), BF₄⁻, B(CN)₄³¹ , CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻(TFSI⁻), N(COCF₃)(SO₂CF₃)⁻, N(SO₂F)₂⁻, N(CN)₂⁻, C(CN)₃⁻, SCN⁻, SeCN⁻, CuCl₂⁻, and AlCl₄⁻.

4. The electrode for a secondary battery according to claim 1, wherein the cellulose nanofiber dispersion is obtained by mixing cellulose nanofibers in a basic solution consisting of sodium hydroxide, urea, or a mixture thereof, and then ultrasonically treating.

5. The electrode for a secondary battery according to claim 4, wherein the cellulose nanofibers have a diameter of 1 to 500 nm and an average fiber length of 0.01 to 2,000 μm.

6. The electrode for a secondary battery according to claim 1, wherein the cationic monomer is at least one selected from the group consisting of (2,3-epoxypropyl)trimethylammonium chloride, (3-chloro-2-hydroxypropyl)trimethylammonium chloride, (3-chloro-2-hydroxypropyl)-lauryldimethylammonium chloride, (3-chloro-2-hydroxypropyl)stearyldimethylammonium chloride, and (methacrylamidopropyl)trimethylammonium chloride, 3-chloropropylimidazolium, 2-hydroxypropylimidazolium, 3-chloropropylpyridinium, 2-hydroxyethylpyridinium, 3-chloropropyltriphenylphosphonium, 3-chloropropyltributylphosphonium, 3-chloropropyldimethylsulfonium, 2-hydroxypropyldimethylsulfonium, 1,3-dichloropropylguanidinium, N-(3-chloropropyl)guanidinium, 3-chloropropylisouronium, 2-hydroxyethylmorpholinium, triethyloxonium tetrachloride phosphate, trimethyloxonium tetrachloride phosphate, N,N-dimethylhydrazine, N,N-diethylhydrazine, methylazonium, ethylazonium, 2-methyloxazolinium, 2-ethyloxazolinium, 2-methylthiazolinium, 2-ethylthiazolinium, 1-methylpiperazinonium, 1,4-dimethylpiperazinonium, and 1,2,3-triazolinium, 1,2,4-triazolinium.

7. The electrode for a secondary battery according to claim 1, wherein the cellulose nanofibers and cationic monomer in the mixture are mixed at a weight ratio of 1:12 to 18.

8. The electrode for a secondary battery according to claim 1,
wherein a weight ratio of the cationic nanocellulose and the fluorine-based polymer is 9:1 to 1:9, and
the fluorine-based polymer is at least one selected from the group consisting of polytetrafluoroethylene (PTFE), polyvinylidene fluoride (PVDF), vinylidene fluoride-hexafluoropropylene copolymer (PVDF-co-HEP), and chlorotrifluoroethylene (CFTF).

9. The electrode for a secondary battery according to claim 1, wherein the binder comprises 0.1 to 3% by weight based on 100% by weight of the electrode for a secondary battery.

10. The electrode for a secondary battery according to claim 1, wherein the cellulose nanofibers and cationic monomer in the mixture are mixed at a weight ratio of 1:14 to 16.

11. The electrode for a secondary battery according to claim 1, wherein the cationic functional group comprises a cationic group of primary to quaternary ammonium ions and an anionic group of nitrate ions or chloride ions or TFSI⁻ (C₂F₆NO₄S₂⁻).

12. The electrode for a secondary battery according to claim 1,
wherein the binder comprises cationic nanocellulose,
the cationic functional group comprises a cationic group of primary to quaternary ammonium ions and an anionic group of nitrate ions or chloride ions or TFSI⁻ (C₂F₆NO₄S₂⁻),
the cellulose nanofibers have a diameter of 30 to 100 nm and an average fiber length of 0.05 to 10 μm,
the cationic monomer is (3-chloro-2-hydroxypropyl)trimethylammonium chloride, and
the cellulose nanofibers and cationic monomer in the mixture are mixed at a weight ratio of 1:14 to 16.

13. A method for manufacturing an electrode for a secondary battery comprising:
preparing cationic nanocellulose surface-modified with a cationic functional group;
preparing an electrode mixed powder including the cationic nanocellulose, or a binder including the cationic nanocellulose and a fluorine-based polymer, a conductive material, and an active material; and
coating the electrode mixed powder on a substrate and then rolling it to manufacture an electrode for a secondary battery.

14. The method for manufacturing an electrode for a secondary battery according to claim 13,
wherein the step of preparing cationic nanocellulose surface-modified with a cationic functional group comprises:
adding cellulose nanofibers to a basic solution and then ultrasonically treating to prepare a cellulose nanofiber dispersion;
mixing a cationic monomer with the cellulose nanofiber dispersion to prepare a mixture; and
heat-treating the mixture to prepare cationic nanocellulose.

15. The method for manufacturing an electrode for a secondary battery according to claim 14, wherein the basic solution is sodium hydroxide, urea, or a mixture thereof.

16. The method for manufacturing an electrode for a secondary battery according to claim 14, wherein the ultrasonic treatment is performed with an amplitude of 1 to 100 μm for 10 to 70 minutes.

17. The method for manufacturing an electrode for a secondary battery according to claim 14, wherein the heat treatment is performed at a temperature of 60 to 100 °C for 7 to 14 hours.

18. The method for manufacturing an electrode for a secondary battery according to claim 13, wherein the cationic functional group in the cationic nanocellulose interacts with lithium cations and polysulfides anions, respectively, during charging and discharging to induce 3-dimensional growth of lithium sulfide, and wherein the cationic functional group includes at least one cationic group selected from the group consisting of primary to quaternary ammonium ions, imidazolium ions (C₃H₅N₂⁺), pyridinium ions (C₅H₆N⁺), phosphonium ions (P(C₂H₅)₄⁺), sulfonium ions (S(CH₃)₃⁺), pyrrolidinium ions (C₄H₁₀N⁺), guanidinium ions (C(NH₂)₃⁺), isouronium ions, thiouronium ions, piperidinium ions (C₅H₁₂N⁺), methylium ions (CH₃⁺), and morpholinium ions (C₄H₁₀NO⁺); and at least one anionic group selected from the group consisting of chloride ions, nitrate ions, TFSI⁻ (C₂F₆NO₄S₂⁻), BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻(TFSI⁻), N(COCF₃)(SO₂CF₃)⁻, N(SO₂F)₂⁻, N(CN)₂⁻, C(CN)₃⁻, SCN⁻, SeCN⁻, CuCl₂⁻, and AlCl₄⁻.

19. The method for manufacturing an electrode for a secondary battery according to claim 14,
wherein the binder comprises cationic nanocellulose,
the cationic functional group comprises a cationic group of quaternary ammonium ions and an anionic group of nitrate ions or chloride ions or TFSI⁻ (C₂F₆NO₄S₂⁻),
the cellulose nanofibers have a diameter of 30 to 100 nm and an average fiber length of 0.05 to 10 μm,
the cationic monomer is (3-chloro-2-hydroxypropyl)trimethylammonium chloride, and
the cellulose nanofibers and cationic monomer in the mixture are mixed at a weight ratio of 1:14 to 16.

20. A secondary battery comprising the electrode of claim 1.
